(19) United States
(12) Patent Application Publication
(10) Pub. No.: US 2024/0281665 A1
(43) Pub. Date: Aug. 22, 2024

(54) METHOD AND SYSTEM FOR SUPPORTING MULTI-AGENT COMMUNICATION

(71) Applicant: NEC Laboratories Europe GmbH, Heidelberg (DE)

(72) Inventors: Carolin LAWRENCE, Heidelberg (DE); Timo SZTYLER, Heidelberg (DE)

(21) Appl. No.: 18/293,813

(22) PCT Filed: Dec. 21, 2021
(86) PCT No.: PCT/EP2021/087079

§ 371 Date: Jan. 31, 2024

(30) Foreign Application Priority Data
Aug. 5, 2021 (EP) 21189882.0
Oct. 15, 2021 (EP) 21202934.2

(51) Int. Cl. G06N 3/092

(52) U.S. Cl. CPC G06N 3/092

(57) ABSTRACT

A method of supporting communication between a background system and an operator environment including one or more operator systems is provided. The systems each comprise an artificial intelligence (AI) model, which, given an input, produces a prediction and/or explanation output. A communication adapter implemented to act as middle-ware between the background system and the operator environment, receives predictions generated by the background system together with associated explanations for the predictions. The communication adapter modifies the received predictions and/or associated explanations under consideration of predefined requirements. The communication adapter transfers the modified predictions and associated explanations to the one or more operator systems of the operator environment. The communication adapter adapts the modified predictions and associated explanations to the one or more operator systems of the operator environment in order to make decisions.

### CROSS REFERENCE TO RELATED APPLICATIONS

This application is a U.S. National Phase application under 35 U.S.C. § 371 of International Application No. PCT/EP2021/087079, filed on Dec. 21, 2021, and claims benefit to European Patent Application No. EP 21202934.2, filed on Oct. 15, 2021 and European Patent Application No. EP 21189882.0, filed on Aug. 5, 2021. The International Application was published in English on Feb. 9, 2023 as WO 2023/011746 A1 under PCT Article 21(2).

### FIELD

The present invention relates to a method of supporting communication between a background system and an operator environment including one or more operator systems, each of the systems including an artificial intelligence, AI, model, which, given an input, produces a prediction and/or explanation output.

Furthermore, the present invention relates to a multi-agent communication system as well as to a communication adapter configured to act as middle-ware in a multi-agent communication system between a background system and an operator environment, the operator environment including one or more operator systems.

### BACKGROUND

AI systems, which have gained more and more importance over the last years, experience a widespread use and are nowadays deployed in many technological and other fields of application. AI systems are often specialized helpers, trained for a specific task. With the increasing use of AI systems in daily life (such as in smart cities or digital government) this leads to situations where different AI systems might have to interact with each other in a multi-agent setup (for reference, see https://en.wikipedia.org/wiki/Multi-agent_system).

In such a multi-agent setup, the output of a first system (henceforth called “background system”) should serve as the input of a second system (henceforth called “operator environment”) and both systems each contain an artificial intelligence (AI) model, which, given an input, produces a prediction output. The operator environment may include several operator systems, each containing an AI model. To seamlessly connect such AI systems, the following requirements may be met: (1) the output of the background system should be in a format that the operator systems within the operator environment can consume as an input, e.g. the input features are from a distribution close to what the operator system's AI model has been trained on; and (2) the background system might have access to sensitive information that should not be given to the operator environment, therefore the output of the background system needs to ensure that no sensitive information is leaked.

An example of the above setup can be found, for instance, in the context of crime prevention: the background system belongs to a city and its AI model predicts expected crime within the city districts, while the operator systems within the operator environment could, e.g., be cleaning machines or a surveillance system with drones. In such a setup, two requirements might arise. (1) The cleaning machines and the surveillance system may require different information to determine their actions to the best. (2) The city might want to preserve its citizen's privacy and ensure that the information given to the operator systems is sufficiently protected.

Bharat Menon Radhakrishnan et al.: “Online Reinforcement Learning in Multi-Agent Systems for Distributed Energy Systems”, 2014 IEEE Innovative Smart Grid Technologies-Asia (ISGT ASIA), Conference Paper, May 2014 disclose a multi-agent system (MAS), wherein a start agent (acting as background system) is enabled to directly communicate with a another agent (acting as a single operator system).

US 2020/0244707 A1 discloses techniques for reinforcement learning that use interactions between agents to achieve better final performance on a task. The technique involves using a reinforcement learning system that selects actions to be performed by a first agent while interacting with a second agent in an environment. The system involves data characterizing the state of the environment and generating corresponding action selection outputs.

Wang et al.: “Learning Efficient Multi-agent Communication: An Information Bottleneck Approach, 2020, https://arxiv.org/abs/1911.06992 also study the problem of communication between agents in a multi-agent setup, where they note that the communicative message should be as informative as possible in order to reduce unnecessary information transfer.

Jiang & Lu, 2018, Learning Attentional Communication for Multi-Agent Cooperation, https://papers.nips.cc/paper/2018/file/6a8018b3a00b69c008601b8becae392b-Paper.pdf and Rangwala & Williams, 2020, Learning Multi-Agent Communication through Structured Attentive Reasoning, https://papers.nips.cc/paper/2020/file/72ab54f9b8c11fae5b923d7f854ef06a-Paper.pdf recognize that in systems with multiple agents, it is difficult for agents to identify relevant information. In their setup, each agent can communicate with each other agent. An agent learning mechanism is in charge to identify the relevant information, i.e., the information it should pay attention to.

Wang et al., 2017, Explanation of Reinforcement Learning Model in Dynamic Multi-Agent System, https://arxiv.org/ftp/arxiv/papers/2008/2008.01508.pdf and Ayzenshtadt et al., 2018, Multi-Agent-Based Generation of Explanations for Retrieval Results Within a Case-Based Support Framework for Architectural Design, https://www.scitepress.org/papers/2018/66502/66502.pdf generate explanations from a multi-agent system, which are only given to the user without further processing it.

In all the above references, the agents directly communicate with each other, which severely limits the efficiency of the communication.

### SUMMARY

In an embodiment, the present disclosure provides a method of supporting communication between a background system and an operator environment comprising one or more operator systems, wherein each of the systems comprise an artificial intelligence (AI) model, which, given an input, produces a prediction and/or explanation output, the method comprising: receiving, by a communication adapter implemented to act as middle-ware between the background system and the operator environment, predictions generated by the background system together with associated explanations for the predictions; modifying, by the communication adapter, the received predictions and/or associated explanations under consideration of predefined requirements; and transferring, by the communication adapter, the modified predictions and associated explanations to the one or more operator systems of the operator environment.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic view illustrating a multi-agent setup including communication support according to an embodiment of the present invention.

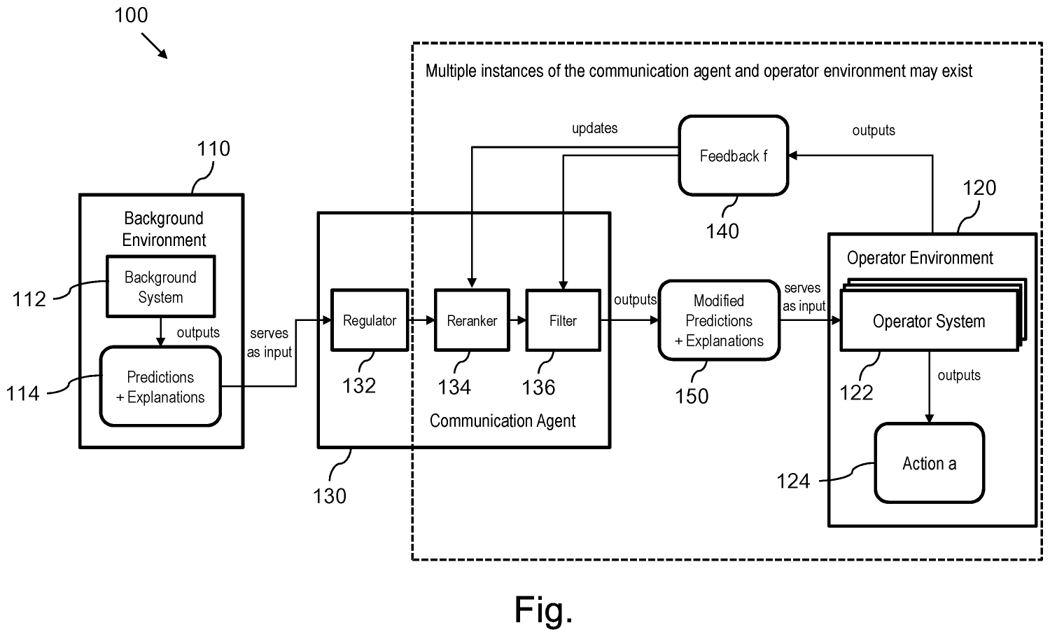

### DETAILED DESCRIPTION

In accordance with an embodiment, the present disclosure improves and further develops a method and a system of the initially described type for supporting communication between a background system and an operator environment, the operator environment including one or more operator systems, in such a way that the communication efficiency is enhanced.

In accordance with another embodiment, the present invention provides a method of supporting communication between a background system and an operator environment including one or more operator systems, each of the systems including an artificial intelligence, AI, model, which, given an input, produces a prediction and/or explanation output, the method comprising: receiving, by a communication adapter implemented to act as middle-ware between the background system and the operator environment, predictions generated by the background system together with associated explanations for the predictions; modifying, by the communication adapter, the received predictions and/or associated explanations under consideration of predefined requirements; and transferring, by the communication adapter, the modified predictions and associated explanations to the one or more operator systems of the operator environment.

Furthermore, in accordance with another embodiment, the present invention provides a multi-agent communication system, the system comprising: a background system and an operator environment including one or more operator systems, each of the systems including an artificial intelligence, AI, model, which, given an input, produces a prediction and/or explanation output, and a communication adapter implemented to act as middle-ware between the background system and the operator environment, wherein the communication adapter is configured to receive predictions generated by the background system together with associated explanations for the predictions; modify the received predictions and/or associated explanations under consideration of predefined requirements; and transfer the modified predictions and associated explanations to the one or more operator systems of the operator environment.

Still further, in accordance with another embodiment, the present invention provides a communication adapter configured to act as middle-ware in a multi-agent communication system between a background system and an operator environment, the operator environment including one or more operator systems, wherein the background system and the one or more operator systems of the operator environment each include an artificial intelligence, AI, model, which, given an input, produces a prediction and/or explanation output, the communication adapter being configured to receive predictions generated by the background system together with associated explanations for the predictions; modify the received predictions and/or associated explanations under consideration of predefined requirements; and transfer the modified predictions and associated explanations to the one or more operator systems of the operator environment.

The present invention proposes a communication adapter, which facilitates the communication from the background system to operator environment, i.e. to the operator systems through the operator environment. This leads to a more effective communication between the systems, which increases the performance of the operator systems and privacy can be ensured. Embodiments of the invention relate to a method of building effective communication between AI systems by using a multi-agent communication interface. The method includes transferring information from a first agent to a second agent by using a communicating adapter. The communicating adapter takes predictions and explanations from the first agent and translates them. The communication adapter may include a re-ranker to re-rank a set of explanations that can be updated based on feedback, a regulator for enforcing regulations, and/or a filter to combine the output of re-ranker and regulator. The feedback may involve using reinforcement learning.

According to embodiments, the invention introduces an automatic procedure with which a first AI system can learn to communicate effectively with a second AI system. As a result, the invention increases the effectiveness of the second system and sensitive data can remain under the protection of the first system. Embodiments of the invention relate to a multi-agent communication interface via predictions and explanations that are adapted for domain-specific systems, wherein the communication adapter acts as a middle-ware system, which learns how to translate information provided by the first agent most effectively to be useful for the second agent. Embodiments aim at filtering the explanations that are given to the second system. In contrast to prior art solutions, embodiments of invention propose that the first agent should indeed explain its prediction to the second agent. Explaining a decision in a multi-agent system is novel and should lead to increase performance because the agents in the system will learn to communicate better and understand when to trust and not to trust a prediction based on the given explanation.

In contrast to prior art solution, the setup according to the present invention defines a “master-slave” architecture, where the first agent (i.e. the prediction system) is the “master” and there is at least one second “slave” agent (i.e., the operator systems in the operator environment). The communication adapter may adjust the first agent's explanations in order to communicate to the second agent more effectively the information (i.e., in form of personalized AI explanations) it may require to make an informed decision. Adjusting not the background system directly, but only the communication adapter provides the advantage that the background system can be used in many different situations where different target systems may require different information explanations from the background system.

According to embodiments, the present invention provides a method for a communication system that can translate information passed from one AI agent to another AI agent in a multi-agent setup. As a pre-requirement, the method may include an initialization step, in which a space of possible predictions (e.g. a set of labels) and a space of possible explanations (e.g. a set of labels or a sequence of a set of labels) may be defined. Furthermore, any regulations that apply (e.g. which explanations cannot be shared) may be defined. The regulations may be imposed by any outside source, e.g., by law or by the owner of the background system. Imposing outside constraints by the communication adapter (and not directly by the background system) has the advantage that, for one and the same background system, it is possible to impose different constraints for different target systems.

As a further pre-requirement, the background environment may find or create an AI system (“background system”) that can deliver predictions of interest and provide explanations for these predictions, where both predictions and explanations should be in the space defined in the initialization step described above.

As described, each operator environment may find or create one or more AI systems (“operator systems”), which can take predictions and explanations as input, where both predictions and explanations should be in the space defined in the initialization step described above. Furthermore, the type of feedback that the systems can give for predictions and explanations may be defined.

Based on the fulfillment of the above pre-requirements, the communication adapter may act between the background system and the operator environment, consisting of or including one or more operator systems, as a middle-ware. Operating the communication adapter to act as middle-ware, offers the advantage of a stable background system: one background system can be used for multiple operator systems (which belong to the same operator environment) without the background system being updated by any operator system in a manner not suitable for another operator system. As a further advantage, the background system can be easily swapped out or replaced by another background system, since it is the communication adapter that knows and remembers what input the operator systems within an operator environment prefer.

According to embodiments of the invention, the communication adapter may include at least one of the following three components:
a. Regulator: This component may be configured to create a system that can enforce the regulations that apply (e.g., as defined in the above mentioned initialization step). This system may be implemented in such a way that it cannot be updated.
b. Reranker: This component may be configured to create a system (e.g. a neural network) that can rerank a set of explanations and which can be updated based on feedback (e.g. using reinforcement learning). The reanker may be configured to consider the output of the Regulator. The re-ranking itself may be implemented as an optional step.
c. Filter: This component may be configured to create a system that takes the output of reranker and determines how much of the reranked list is passed on. The decision of how much is passed on can be updated based on feedback.

According to embodiments of the present invention, the method/system may include an update procedure: For each output of the communication adapter, feedback may be requested from the operator environment. This information may be stored and it may be determined when and how to update the communication adapter based on this feedback. By way of providing feedback, the input for the operator systems within the operator environment improves over time, which assists the operator systems in making more informed decisions.

There are several ways how to design and further develop the teaching of the present invention in an advantageous way. To this end it is to be referred to the dependent claims on the one hand and to the following explanation of preferred embodiments of the invention by way of example, illustrated by the figure on the other hand. In connection with the explanation of the preferred embodiments of the invention by the aid of the figure, generally preferred embodiments and further developments of the teaching will be explained.

The only Fig. shows an overview of an overall multi-agent system 100 in accordance with an embodiment of the present invention. The system 100 includes a background environment 110 including a background system 112 and an operator environment 120 including one or more operator systems 122. The background system 112 and the operator systems 122 each include an artificial intelligence, AI, model (not explicitly shown in the Fig.), which, given an input, produces a prediction output. For instance, the background system 112 may be configured to monitor a domain of interest and may produce predictions as well as explanations for these predictions, as shown at 114. The predictions and explanations 114, which may be provided, e.g., periodically, as may be required or on demand, may be ranked in a generic way, i.e., without any constraints and domain independent.

According to the illustrated embodiment, the system 100 comprises a communication adapter 130, which acts as a middle-ware system in the multi-agent setup when the background system 112 provides information to the one or more operator systems 122 within the operator environment 120. Specifically, as depicted in the Fig., the predictions and explanations 114 of the background system are the input into the communication adapter 130.

According to an embodiment of the invention, the communication adapter 130 may include a regulator component 132, a reranker component 134 and a filter component 136. These components may be arranged in a pipeline fashion, as shown in the Fig. However, in other embodiments, the components may also be arranged in a different way, e.g., the regulator 132 and the reranker 134 in parallel ahead of the filter component 136.

Generally, the communication adapter 130 may be configured to execute two steps. Both steps may be executed either subsequently in a pipeline fashion following the configuration show in the Fig. or simultaneously.

First, based on regulations defined by an outside source (e.g. by an owner of the background system 112), the regulator 132 may update the predictions and explanations 114 as received from the background system 112 to ensure they follow the supplied regulations. For example, the regulator 132 might remove or replace a series of words in the predictions or explanations 114 deemed sensitive by the owner of the background system 112. In the Fig., the dashed line represents a (possibly) untrusted environment from the viewpoint of the background environment 110.

Second, based on one prediction of the predictions and explanations 114, the reranker 134 may examine the associated explanations and may update their ordering. To this end, the reranker 134 may use, e.g., a neural network. As will be explained in detail later, the reranker can be updated based on feedback 140 from the operator environment 120, i.e., collected from one or more of the operator systems 122, e.g., via a neural network that can be updated using a reinforcement-learning algorithm.

Next, the filter 136 may be applied to the updated and reranked predictions and explanations. The filter 136 may be configured, for example, to filter all but the top k explanations. The parameter k could either be set manually or be learnt and updated based on feedback 140 (e.g. via another neural network).

After this step, the communication adapter 130 outputs the modified (i.e. updated, reranked and filtered) predictions and explanations 150. The modified predictions and explanations 150 serve as input to the operator environment 120; hence, to the one or more operator systems 122, which may be configured to output a specific Action a, as shown at 124. An operator system 122 could be, for example, a neural network.

Based on the received modified predictions and explanations 150 and the actions 124 generated by the operator systems 122, the operator environment 120 may then generate and output a feedback f, as is shown at 140. This feedback 140 may quantify how helpful the modified predictions and explanations 150 were for the operator systems 122. For instance, the feedback 140 could be a numerical score in a pre-defined range, such as [0, 1].

According to embodiments, the feedback 140 may then be used to update the reranker 134 and, optionally, the filter 136 of the communication adapter 130. Consequently, the communication adapter 130 will improve over time in order to provide a better-personalized ranked list for both, predictions and explanations. The updates to the communication adapter 130 may happen after each feedback f is received or at any other pre-determined interval.

In accordance with embodiments of the present invention, each background environment 110 may communicate with more than one operator environment 120. In this case, each operator environment 120 could get assigned its own communication adapter 130 so that each communication adapter 130 may specifically adapt to each operator environment 120 in order to be most effective in translating the information from the background environment 110 for the corresponding operator environment 120.

According to embodiments, the present invention may be suitably applied in the healthcare sector, in particular in connection with assisted living and patient assistance. In a corresponding use case, it may be provided that smart devices observe/monitor people during their daily routine. This should facilitate a more independent live for elderly but also support people in certain situations, e.g. after a surgery.

In such case, the background environment 110 shown in the Fig. may include smart devices, e.g. on-body sensors, which may observe and record the daily routine/activities, vital parameter of their user, and/or further related information. The recorded data may be transferred to the background system 112 that includes an AI module configured to analyze the data, to make certain predictions and to provide explanations for the predictions. Specifically, the background system 112 may predict whether the health condition of the respective supervised person changes or if certain diseases become more likely due to the lifestyle. For instance, the background system 112 may predict a weight gain and one of the corresponding explanations may be ‘unhealthy diet’.

According to embodiments of the invention, such predictions and explanations may be transferred via the specifically adapted or adaptable communication adapter 130 to an operator environment 120 including one or more operator systems 122 (e.g., a smart caretaker) as target AI systems. Specifically, the communication adapter 130 may be adapted (e.g. after a training phase, possibly including feedback from the operator systems 122) in such a way that the predictions along with a (ranked) list of explanations is personalized to the operator environment 120, and thus also to the operator systems 122. For instance, the communication adapter 130 may be configured in such a way that it only provides those explanations, which are relevant/interesting for a respective operator system 122 within the operator environment 120. Furthermore, the communication adapter 130 may only provide those explanations for which the operator system 122 is permitted to process the respective information.

In the above scenario, the operator systems 122, which are directly influenced by the prediction and explanations transferred from the communication adapter 130, may include, e.g., a smart sport equipment. In this case, for instance, this equipment could, in reaction to a weight gain (prediction) caused by unhealthy diet (explanation), generate as output action 124 a dynamic adaptation of a level of difficulty. According to a further example, an operator system 122 could be a smart remote consult. In this case, an output action 124 generated by an AI model of the smart remote consult (reactive to the modified predictions and explanations 150 received from the communication adapter 130) may include transmitting data automatically to a monitoring system of a physician which can raise an alarm. According to yet another example, an operator system 122 cloud be a smart caretaker unit, which-as output action 124-takes care of food preparation or drug administration. As a last example (although, as will appreciated by those skilled in art, further use cases can be envisioned), an operator system 122 could be a smart video surveillance system. In this case, as it is not fine to record the private area of a person permanently, it might be enabled/adjusted when an emergency is recognized.

According to further embodiments, the present invention may be suitably applied in the public safety sector, in particular in connection with crime prevention. In a corresponding use case, it may be provided that the police (as the background environment 110 shown in the Fig.) observes the different areas/district in a city and records the crimes.

A background system 112 may be implemented in form of a central unit that has access database of the police force. This may include information of the respective district, including characteristics of the social life, availability of, e.g., schools and police forces, and ethnicities. The background system 112 may include an AI module configured to analyze the recorded data, to make certain predictions (e.g., with regard to crime type and location) and to provide explanations for the predictions (e.g. in form of evidence or related situations). Specifically, the background system 112 may predict that a certain district is likely to drift into crime (e.g., the number of crimes increases) and may provide one or more explanations for the predicted development.

According to embodiments of the invention, such predictions and explanations may be transferred via the specifically adapted or adaptable communication adapter 130 to an operator environment 120 including one or more operator systems 122 (e.g., a surveillance system) as target AI systems. Specifically, the communication adapter 130 may be adapted (e.g. after a training phase, possibly including feedback from the operator environment 120; hence, from one or more operator systems 122) in such a way that the predictions along with a (ranked) list of explanations is personalized to the respective operator system 122. For instance, the communication adapter 130 may be configured in such a way that it only provides those explanations, which are relevant/interesting for a certain operator system 122. Furthermore, the communication adapter 130 may only provide those explanations to the operator environment 120 for which the respective operator system 122 is permitted to process the respective information.

In the above scenario, the operator systems 122, which are directly influenced by the prediction and explanations transferred from the communication adapter 130, may include, e.g., a surveillance system (including, e.g., stationary cameras and possibly drones). In this case, for instance, the surveillance system could, in reaction to an increasing crime prognosis (prediction) caused, e.g., by a detected increase of drug consumption (explanation), generate as output action 124 the activation of a higher number of security cameras. According to further examples, an operator system 122 could be a digital advertising panel system (to fight disinformation), cleaning machines (to increase the moral), and/or a road control and management system (to ensure that certain goods transports only pass certain districts).

According to further embodiments, the present invention may be suitably applied in smart cities, in particular in connection with intelligent (traffic) routing. In a corresponding use case, it may be provided that the city/urban administration (as the background environment 110 shown in the Fig.) observes the movements of people and cars (swarm data) within the city. To this end, the background environment 110 may include a smart sensor network of the city as a data source, which records, e.g., the amount of people/cars, reasons for the jams/bottlenecks (cameras), and social background.

The recorded data may be transferred to a background system 112 that includes an AI module configured to analyze the data, to make certain predictions and to provide explanations for the predictions. For instance, the AI module may forecast movement profiles of people along with how many people will come to which part of the city on what day and for which reasons. Alternatively or additionally, the background system 112 may be configured to predict (traffic) jams, bottlenecks, and supply demand (e.g., various public services) and to provide corresponding explanations (e.g., related events or early recognition due to evidence).

According to embodiments of the invention, such predictions and explanations may be transferred via the specifically adapted or adaptable communication adapter 130 to an operator environment 120 including one or more operator systems 122 (e.g., a public transport system) as target AI systems. Specifically, the communication adapter 130 may be adapted (e.g. after a training phase, possibly including feedback from the operator environment 120; hence, from one or more operator systems 122) in such a way that the predictions along with a (ranked) list of explanations is personalized to a respective operator system 122. For instance, the communication adapter 130 may be configured in such a way that it only provides those explanations, which are relevant/interesting for a certain operator system 122. Furthermore, the communication adapter 130 may only provide those explanations to the operator environment 120 for which the respective operator system 122 is permitted to process the respective information.

In the above scenario, the operator systems 122, which are directly influenced by the prediction and explanations transferred from the communication adapter 130, may include, e.g., a public transport system. In this case, for instance, the public transport system could, in reaction to an increasing traffic volume (prediction) caused, e.g., by a specific event taking place in the city (explanation), increase—as output action 124—the bus and tram frequencies on certain lines passing by the event location. According to further examples, an operator system 122 could be a logistic system (that may adapt—as output action 124—an amount of provided resources, or the routes of their vans), a smart parking facility (that may inform—as output action 124—smart cars where they should park), and/or a smart waste management system (that informs—as output action 124—users about the amount and type of expected waste).

As will be appreciated by those skilled in the art, apart from the use cases explicitly described above, implementation of embodiments of the present invention is straightforward for a variety of further applications where AI predictions and explanations are presented to another AI system or human users.

In a concrete instantiation, a system according an embodiment of the present invention may be implemented by deploying the following components:
1. The background system 112 providing the predictions together with corresponding explanations may be implemented via learning of knowledge base representations (in particular as described in A. Garcia-Duran, M. Niepert: “KBLRN: End-to-End Learning of Knowledge Base Representations with Latent, Relational, and Numerical Features”, 2017 Uncertainty in Artificial Intelligence, pp 372-381, arXiv: 1709.04676v3, which is hereby incorporated by reference herein in its entirety) together with an explainable AI mechanism, for instance a Gradient Rollback mechanism (in particular as described in C. Lawrence, T. Sztyler, and M. Niepert: “Explaining neural matrix factorization with gradient rollback”, in The Thirty-Fifth AAAI Conference on Artificial Intelligence (AAAI-21), 2021, which is hereby incorporated by reference herein in its entirety).
2. The communication adapter 130 may be instantiated as follows:
   a. The reranker 134 may be implemented as a neural network, which can be updated based on feedback using, e.g., a (multi-agent) reinforcement learning algorithm.
   b. The implementation of the regulator 132 depends on the use case, it could for example be a hand-written set of transformation rules.
3. Each operator system 122 could be implemented as a neural network of a customer or business partner.

In practice, an operator system 122 might sometimes be a human. Inventors ran such an experiment based on the above-described framework. For this, inventors had available a graphical user interface, which allows human users to give feedback for the presented explanations. Initial experiments (see table below) show that the invention leads to a setup where human users are faster (average time (Avg.) and standard deviation (Std.)) and require less explanations ( #2 instead of #23). Specifically, the experiments show that communication efficiency due to the communication adapter according to the present invention has increased by a factor of nearly 2: humans arrive at the correct decision nearly twice as fast as without the communication adapter while accuracy stays the same.

| | Acc. (%) | Time (s) | # Expl. |
|---|---|---|---|
| No Communication Agent | 98.89 | 152 ± 53.10 | 23 |
| With Communication Agent | 98.89 | 57 ± 14.62 | 2 |
| Δ | 0.0 | −95 ± 38.48 | −21 |

To conclude, with the communication adapter, humans can make decisions significantly faster, saving over a minute per decision while retaining the same accuracy.

To summarize, embodiments of the present invention include one or more of the following inventive steps:
1. Transfer explanations for a prediction from one agent (background system) to another agent (operator environment, including one or more operator systems), thereby improving communication. In this context, it is to be assumed that the explanation set of the background system contains at least some explanations that are actually helpful for the operator environment.
2. A communication adapter which i) takes the predictions and corresponding explanations from the first agent (background system) ii) translate those under consideration of certain requirements, and iii) transfers the translated data to the second agent (operator environment, including one or more operator systems). The translation step may consider the following requirements:
   a. The needs of the target agent concerning which explanations are most suitable for the target agent.
   b. The regulations imposed by outside sources, e.g., by law or the owner.
3. The communication adapter is able to receive feedback from the operator agents and overtime adapts to its needs (see Inventive Step 2a).

Many modifications and other embodiments of the invention set forth herein will come to mind to the one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method of supporting communication between a background system and an operator environment comprising one or more operator systems, wherein each of the systems comprise an artificial intelligence (AI) model, which, given an input, produces a prediction and/or explanation output, the method comprising:
receiving, by a communication adapter implemented to act as middle-ware between the background system and the operator environment, predictions generated by the background system together with associated explanations for the predictions:
modifying, by the communication adapter, the received predictions and/or associated explanations under consideration of predefined requirements: and
transferring, by the communication adapter, the modified predictions and associated explanations to the one or more operator systems of the operator environment.

2. The method according to claim 1, further comprising in an initialization step comprising:
defining a first space of possible predictions and defining a second space of possible explanations providable by the background system.

3. The method according to claim 2, wherein the first space of possible predictions and the second space of possible explanations comprise a set of labels or a sequence of a set of labels.

4. The method according to claim 1, wherein the predefined requirements considered by the communication adapter to modify the received predictions and/or associated explanations comprise the needs of the operator environment concerning which explanations are most suitable for the operator environment and/or regulations imposed by an outside source.

5. The method according to claim 1, further comprising:
requesting, for outputs of the communication adapter, feedback from the one or more operator systems of the operator environment; and
updating the communication adapter based on the feedback.

6. The method according to claim 1, further comprising:
examining, by a reranker component of the communication adapter, a set of explanations received from the background system and updating an ordering of the explanations.

7. The method according to claim 6, further comprising:
receiving, by a filter component of the communication adapter, the explanations with updated ordering from the reranker component; and
selecting, by the filter component, a predefined or configurable number of top-ranked explanations according to the updated ordering, and passing on the selected explanations to the operator environment.

8. The method according to claim 1, wherein a same background system is used for multiple operator systems of the operator environment.

9. A multi-agent communication system, the system comprising:
a background system and an operator environment comprising one or more operator systems, each of the systems comprising an artificial intelligence (AI) model, which, given an input, produces a prediction and/or explanation output, and
a communication adapter implemented to act as middle-ware between the background system and the operator environment, wherein the communication adapter is configured to:
receive predictions generated by the background system together with associated explanations for the predictions:
modify the received predictions and/or associated explanations under consideration of predefined requirements: and
transfer the modified predictions and associated explanations to the one or more operator systems of the operator environment.

10. The system according to claim 9, wherein the communication adapter comprises a regulator component configured to update predictions and explanations received from the background system in such a way that the predictions and explanations comply with regulations defined by an outside source.

11. The system according to claim 9, wherein the communication adapter comprises a reranker component configured to examine a set of explanations received from the background system and to update the ordering of the explanations.

12. The system according to claim 11, wherein the reranker component is implemented as a neural network that is updated using a reinforcement-learning algorithm based on feedback from the operator environment.

13. The system according to claim 11, wherein the communication adapter comprises a filter component configured to:
receive the explanations with updated ordering from the reranker component, select a predefined or configurable number of the top-ranked explanations according to the updated ordering, and
pass on the selected explanations to the operator environment.

14. The system according to claim 9, wherein the background system providing the predictions together with corresponding explanations is configured to apply a knowledge base representations learning mechanism together with an explainable AI mechanism.

15. A communication adapter configured to act as middle-ware in a multi-agent communication system between a background system and an operator environment, the operator environment comprising one or more operator systems, wherein the background system and the one or more operator systems of the operator environment each comprise an artificial intelligence (AI) model, which, given an input, produces a prediction and/or explanation output, the communication adapter being configured to:
receive predictions generated by the background system together with associated explanations for the predictions:
modify the received predictions and/or associated explanations under consideration of predefined requirements; and
transfer the modified predictions and associated explanations to the one or more operator systems of the operator environment.

16. The system according to claim 14, wherein the explainable AI mechanism is a gradient rollback mechanism.
